(19) United States
(12) Patent Application Publication
(10) Pub. No.: US 2024/0298610 A1
(43) Pub. Date: Sep. 12, 2024

(54) TEMPERATURE REGULATING CANINE HARNESS

(71) Applicant: James Taylor, Orlando, FL (US)

(72) Inventor: James Taylor, Orlando, FL (US)

(21) Appl. No.: 18/119,352

(22) Filed: Mar. 9, 2023

(51) Int. Cl. A01K 27/00

(52) U.S. Cl. CPC A01K 27/002

(57) ABSTRACT

A temperature regulating canine harness includes an upper panel and a lower panel, each having a front end, a back end and a central section. The panels are connected together by a plurality of adjustable straps. The upper panel includes a bilaterally symmetrical shape for conform to the shape of a canine's back, and the lower panel includes a shape and size that is designed to conform to the shape of a canine's chest. A plurality of cooling pockets is disposed along an inside facing surface of the upper and lower panels. Each of the pockets function to receive and position a thermal regulation device against the back, side or chest area of the dog wearing the harness. A leash ring and pocket for receiving and storing a tracking device such as a smartwatch or GPS locator device are provided along the central section of the upper panel.

### TECHNICAL FIELD

The present invention relates generally to pet products, and more particularly to a canine harness having a plurality of temperature regulating devices positioned throughout.

### BACKGROUND

The statements in this section merely provide background information related to the present disclosure and may not constitute prior art.

Many pet owners routinely take their dogs outdoors for exercise and/or companionship. Whether it be a leisurely walk around the neighborhood, a jog along the beach or a rigorous run through the park, it is not uncommon to see man and animal together in the great outdoors.

In almost all instances, local ordinances require that the pet remain leashed at all times when outside of a gated area. As such, there are no shortages of commercially available canine body harnesses which are worn about the animal and connect to a leash. Such harnesses are a popular alternative to traditional neck collars as they do not pull on the head or neck of the dog.

In either instance, physical exercise is extremely important for the health and wellbeing of canines, but when the weather turns warm, especially in southern climates, it is imperative that the animal remain cool so as to avoid the very real possibility of heat stroke. This is especially true when using a body harness, as the material of the harness covers much of the dog's body. Although pet owners typically bring water for the dog to drink, this may not be sufficient to lower their body temperature and/or keep the animal's body temperature cool.

Accordingly, it would be beneficial to provide a canine body harness having a plurality of integrated temperature regulating devices for maintaining the temperature of the dog at a safe and comfortable level.

### SUMMARY OF THE INVENTION

The present invention is directed to a temperature regulating canine harness. One embodiment of the present invention can include an upper panel having a front end, a back end, and a central section. The upper panel can include a bilaterally symmetrical shape that is designed to conform to the shape of a canine's back. The invention can also include a lower panel that is connected to the upper panel by a plurality of adjustable straps. The lower panel can also include a front end, a back end and a central section having a shape and size that is designed to conform to the shape of a canine's chest.

One embodiment of the present invention can include a plurality of cooling pockets that are disposed along an inside facing surface of the upper and lower panels. Each of the pockets can receive and position a thermal regulation device such as a cold pack against the back, side or chest area of the dog wearing the harness.

The harness can also include a ring for engaging a leash clip, and a transparent pocket for receiving and storing a tracking device such as a smartwatch or GPS locator device, for example.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of the temperature regulating canine harness that is useful for understanding the inventive concepts disclosed herein.

FIG. 2 is a bottom view of the temperature regulating canine harness in accordance with one embodiment of the invention.

FIG. 3 is a perspective view of the temperature regulating canine harness in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described and illustrated for use with a canine, this is for illustrative purposes only. To this end, other embodiments are contemplated wherein the harness can be constructed to be used with other types of pets.

### Definitions

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples of connectors include, but are not limited to, flexible strips of interlocking projections with a slider (i.e., zipper), thread-to-connect, twist-to-connect, and push-to-connect type devices, opposing strips of hook and loop material (e.g., Velcro®), attractively oriented magnetic elements or magnetic and metallic elements, buckles such as side release buckles, clamps, sockets, clips, carabiners, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

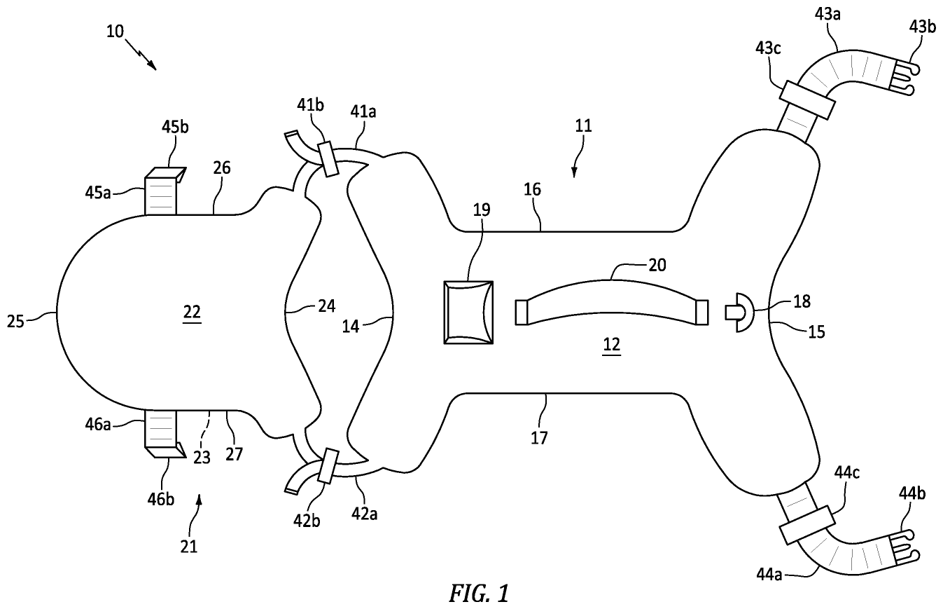

FIGS. 1-5 illustrate one embodiment of a temperature regulating canine harness 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown best at FIGS. 1-3, the canine harness 10 can include an upper panel 11, and a lower panel 21 that are joined together by a plurality of adjustable connectors.

The upper panel 11 can include an elongated body member having an outside surface 12, an inside surface 13, a semi-circular front end 14, a semi-circular back end 15, and a pair of sides 16 and 17. The upper panel can preferably include a bilaterally symmetrical shape that is designed to conform to the back and upper sides of a canine, so as to extend from just behind the dog's neck to a location posterior of the withers.

In one embodiment, a metallic ring 18, loop, or other such component can be positioned centrally along the outside surface of the top panel. The ring can function to receive and engage the clip of a leash or other such device.

In one embodiment, a pouch 19 can be provided along the outside surface of the top panel, ideally at a location adjacent to the front end 14 metallic ring. The pouch is designed to receive and store a tracking device such as a smartwatch or GPS locator device, for example, in order to allow a user to locate their pet in the event they become separated. To this end, the pouch will preferably be constructed from a transparent material so as to allow a user to easily see an inserted device and confirm it is operating when walking their dog using the harness, and to ensure signals to/from the device are not blocked by the harness material.

In one embodiment, an elongated handle 20 can be provided along the outside surface of the top panel, ideally at a location that extends from the pouch 19 to the back end 15. The handle can function to allow a user to guide or otherwise restrain a canine wearing the harness.

The lower panel 21 can also include an elongated body member having an outside surface 22, an inside surface 23, a semi-circular front end 24, a semi-circular back end 25, and a pair of sides 26 and 27. The lower panel can preferably include a bilaterally symmetrical shape that is designed to extend from the prosternum of the dog, along the chest centerline to a position anterior or caudal of the dog's forearms.

In the preferred embodiment, both of the panels 11 and 21 can be constructed from a strong and lightweight material such perforated nylon, PVC coated polyester or other such materials, for example, which are designed to allow air to easily pass therethrough.

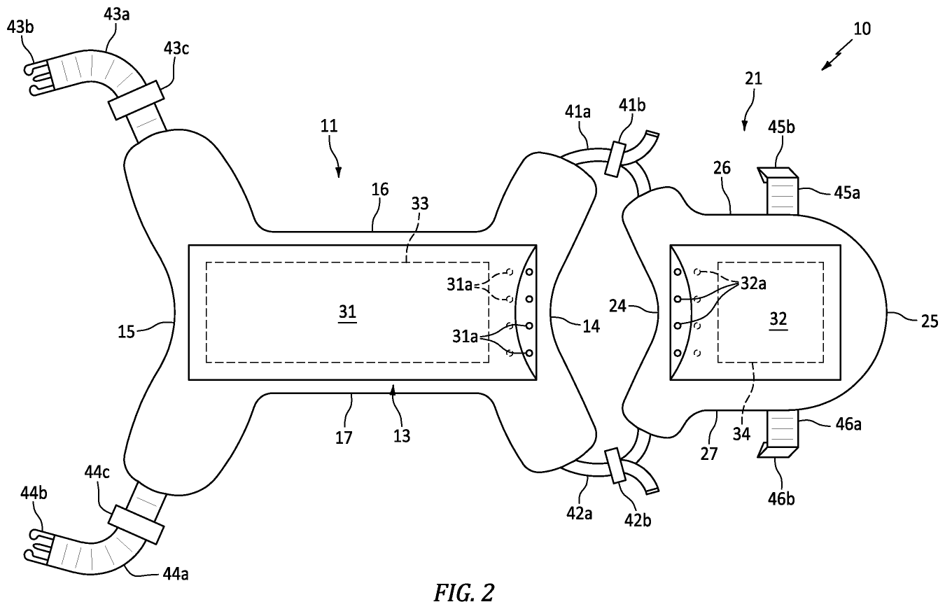

As shown best at FIG. 2, pockets 31 and 32 can be provided along the inside surfaces of the upper and lower panels 11 and 21, respectively. Each of these pockets can include any number of different shapes and sizes and can function to receive the below described cold packs. In the preferred embodiment, each of the pockets will be constructed from a cloth material such as cotton, for example, so as to allow the cold generated by the packs to pass through the pocket and onto the animal, while protecting the animal's fur and skin from frostbite.

As shown, the harness can include a pair of cold packs 33 and 34 which can be positioned within pockets 31 and 32, respectively. In this regard, each of the cold packs will preferably include a shape and a size that is complementary to the shape and size of the pocket into which they are to be stored. As described herein, each of the cold packs can include, comprise or consist of any type of thermal regulation/thermal generation device such as a reusable or non-reusable leakproof refrigerant gel, for example, that can rapidly absorb heat and/or provide an instantly cold surface area via an endothermic reaction.

Although described and illustrated with regard to two pockets that are centrally located along the inside facing surfaces of the panels for receiving cold packs, this is for illustrative purposes only. To this end, other embodiments are contemplated wherein a a greater or lesser number of pockets are provided along one or both of the panels, and/or wherein the pockets are located at different positions along one or both of the panels. Additionally, other embodiments are contemplated wherein heat producing packs are substituted for the above-described cold packs, so as to provide warmth to the animal in cold temperature climates.

In the preferred embodiment, each of the pockets can be individually accessible via connectors 31a and 32a, such as magnets or strips of hook and loop material, for example, so as to allow the cold packs to be removable in nature. Such a feature advantageously allows a user to carry spare instant-cold gel packs and to be able to replace existing packs within the pockets of the harness when needed on the go. Of course, other embodiments are contemplated wherein reusable thermal regulation devices are sealed within the pockets, so as to not be individually replaceable.

As shown, the upper and lower panels can be connected by a plurality of adjustable straps. In the illustrated embodiment, the front straps 41a and 42a can be permanently connected along the front ends 14 and 24 of the upper and lower panels 11 and 21, respectively, and two pairs of rear straps 43a, 44a, 45a and 46a can be removably connected via male buckles 43b and 44b and female buckles 45b and 46b, respectively.

In one embodiment, length adjustment mechanisms 41b, 42b, 43c and 44c can be provided along the straps to allow the front and back ends of the harness to be individually and precisely adjusted for the shape of the particular dog onto which the harness is to be fitted, and to accommodate dogs of varying sizes and body shapes. Of course, any number of other types of connectors suitable for securing the panels together about a dog are also contemplated.

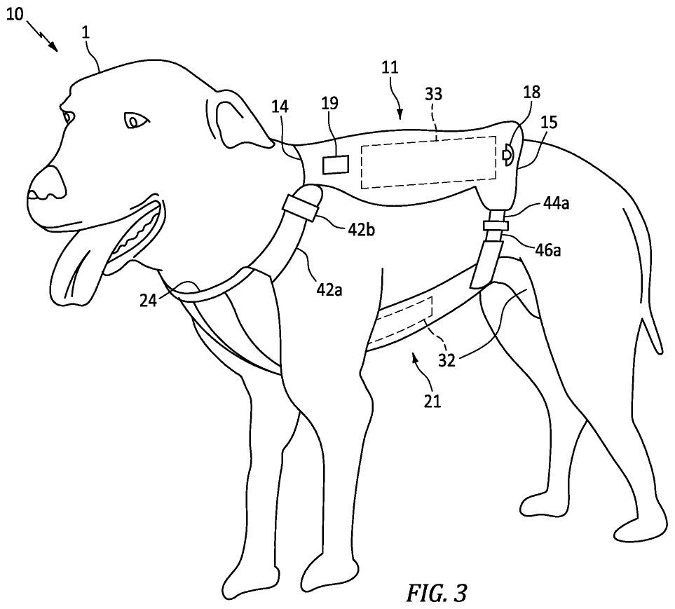

FIG. 3 illustrates one embodiment of the harness in operation. As shown, the harness 10 can be fitted to a dog 1 whereby the front ends 12 and 22 of the panels form an adjustable circumferential loop about the dog's neck in a position cranial to the forearms, and the back ends 14 and 24 of the panels form an adjustable circumferential loop about the chest of the dog in a position caudal to the forearms.

When so positioned, the cooling pockets 31 in the central body sections will be positioned against the back, chest and/or sides of the dog, so as to provide cooling relief to the animal while ensuring their temperature does not rise to a dangerous level.

Although described above with regard to a harness for providing cold air to dogs, this is for illustrative purposes only. To this end, other embodiments are contemplated wherein the harness is shaped and sized so as to be used with other animals. Moreover, other construction components are contemplated for use in cold weather environments wherein the cold packs are replaced with heat producing packs.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An animal harness, comprising:
an upper panel having a front end, a back end, a central body section, and a pair of sides;
a lower panel having a front end, a back end, a central body section, and a pair of sides;
a plurality of adjustable straps that are connected between the upper panel and the lower panel; and
at least one cooling pocket that is provided along one of the upper panel or the lower panel.

2. The harness of claim 1, wherein the upper panel includes a bilaterally symmetrical shape, and is configured to engage a back area of a canine.

3. The harness of claim 2, wherein the lower panel includes a bilaterally symmetrical shape, and is configured to engage a chest area of the canine.

4. The harness of claim 3, wherein one of the at least one cooling pocket is provided along an inside facing surface of the upper panel.

5. The harness of claim 4, wherein the another of the at least one cooling pocket is provided along an inside facing surface of the lower panel.

6. The harness of claim 1, further comprising:
a pouch that is located along an outside facing surface of the upper panel.

7. The harness of claim 6, wherein the pouch is configured to receive a tracking device.

8. The harness of claim 1, further comprising:
a ring that is positioned along an outside facing surface of the upper panel.

9. The harness of claim 8, wherein the ring is constructed from metal and is configured to engage a clip of a leash.
